(19) United States
(12) Patent Application Publication
(10) Pub. No.: US 2015/0290652 A1
(43) Pub. Date: Oct. 15, 2015

(54) Meat Shredding Apparatus and Method

(71) Applicant: Infusion Living LLC, West Chester, PA (US)

(72) Inventors: Paul K. Metaxatos, Swampscott, MA (US); Joel F. Nevin, Portsmouth, NH (US); Alice S. Mayfield, Boston, MA (US); Julie L. Napolitan, Arlington, MA (US); Christine L. Reibl, West Chester, PA (US); William P. Reibl, West Chester, PA (US)

(73) Assignee: Infusion Living LLC, West Chester, PA (US)

(21) Appl. No.: 14/251,348

(22) Filed: Apr. 11, 2014

(51) Int. Cl. B02C 18/14; A22C 17/00; B02C 18/16

(52) U.S. Cl. CPC B02C 18/144; B02C 18/16; A22C 17/0006

(57) ABSTRACT

Apparatus and method are described for the shredding of cooked or uncooked meats in a clean, easy, and convenient manner. Apparatus are described wherein a lid portion fits together with a base portion to form a shredding chamber with interlocking sharp blades that are arranged to allow the lid portion and the base portion rotate around each other to move the blades within the shredding chamber and through the meat, thereby shredding the meat.

### FIELD OF THE DISCLOSURE

Aspects of the present disclosure relate to devices and methods for preparation of meats, and, in particular, for shredding meats.

### BACKGROUND

Dishes prepared with shredded or pulled meats have grown in popularity in recent years. This may be due to the rise in popularity of at-home barbecuing which often uses shredded meat ingredients, and to the growing demand to be able to make full use of leftover cooked meats for both economic and environmental reasons, while still enjoying delicious meals.

Preparation of shredded meats, however, is labor intensive, inconvenient, and messy. At-home chefs and others wishing to prepare shredded meats may decide that known techniques of shredding or pulling are too inconvenient to be worth the effort.

### SUMMARY

One objective of the present disclosure may be to introduce apparatus and methods that are capable of shredding cooked or uncooked meats in a manner that is easy, convenient, and clean.

Apparatus and methods are described for the shredding of cooked or uncooked meats in a clean, easy, and convenient manner. Apparatus are described wherein a lid portion fits together with a base portion to form a shredding chamber with interlocking blades that are arranged to allow the lid portion and the base portion to rotate around each other to move the blades within the shredding chamber and through the meat, thereby shredding the meat.

One or more alternate or additional objectives may be served by the present disclosure, e.g., as may be apparent by the following description. Embodiments of the disclosure include any apparatus, machine, system, method, articles, or any one or more subparts or subcombinations of such apparatus (singular or plural), system, method, or article, e.g., as supported by the present disclosure.

### BRIEF DESCRIPTION OF THE DRAWINGS

Example embodiments will be described with reference to the following drawing figures in which:

FIG. 1 is a schematic diagram showing the top view of a meat shredding apparatus according to one embodiment;

FIG. 2 is a schematic diagram showing an identical front and rear view of a meat shredding apparatus according to one embodiment;

FIG. 3 is a schematic diagram showing an identical left side and right side view of a meat shredding apparatus according to one embodiment;

FIG. 4 is a schematic diagram showing a bottom side view of a meat shredding apparatus according to one embodiment;

FIG. 5 is a schematic diagram showing a perspective view of a meat shredding apparatus according to one embodiment;

FIG. 6 is a schematic diagram showing an exploded view of a meat shredding apparatus according to one embodiment;

FIG. 7 is a schematic diagram showing a top view of a base of a meat shredding apparatus according to one embodiment;

FIG. 8 is a schematic diagram showing an identical front, rear, and side view of a base of a meat shredding apparatus according to one embodiment;

FIG. 9 is a schematic diagram showing a perspective view of a base of a meat shredding apparatus according to one embodiment;

FIG. 10 is a schematic diagram showing a top view of a lid of a meat shredding apparatus according to one embodiment;

FIG. 11 is a schematic diagram showing an identical front and rear view of a lid of a meat shredding apparatus according to one embodiment;

FIG. 12 is a schematic diagramming showing an identical left and right side view of a lid of a meat shredding apparatus according to one embodiment;

FIG. 13 is a schematic diagram showing a bottom view of a lid of a meat shredding apparatus according to one embodiment;

FIG. 14 is a schematic diagram showing a perspective view of a lid of a meat shredding apparatus according to one embodiment;

FIG. 15 is a schematic diagram showing the top view of an topless knob for a meat shredding apparatus according to one embodiment;

FIG. 16 is a schematic diagram of an identical front, side, and rear view of an topless knob for a meat shredding apparatus according to one embodiment;

FIG. 17 is a schematic diagram of a perspective view of an topless knob for a meat shredding apparatus according to one embodiment;

FIG. 18 is a schematic diagram of an identical front, side, and rear view of a knob top for a meat shredding apparatus according to one embodiment;

FIG. 19 is a schematic diagram of a perspective view of a knob top for a meat shredding apparatus according to one embodiment;

FIG. 20 is a schematic diagram of a knob cap for a meat shredding apparatus according to one embodiment;

FIG. 21 is a schematic diagram of a perspective view of a knob cap for a meat shredding apparatus according to one embodiment;

FIG. 22 is a schematic diagram showing an exploded view of a meat shredding apparatus with runner snaps according to one embodiment;

FIG. 23 is a schematic diagram of an identical front and side view of a runner snap for a meat shredding apparatus according to one embodiment;

FIG. 24 is a schematic diagram of a perspective view of a runner snap for a meat shredding apparatus;

FIG. 25 is a schematic diagram showing an exploded view of a meat shredding apparatus with a slide runner according to one embodiment;

FIG. 26 is a schematic diagram of a front view of a slide runner for a meat shredder according to one embodiment;

FIG. 27 is a schematic diagram of a perspective view of a slide runner for a meat shredding apparatus according to one embodiment;

FIG. 28 is a schematic diagram of a bottom view of a blade of a meat shredding apparatus according to one embodiment;

FIG. 29 is a schematic diagram of an identical front and rear view of a blade of a meat shredding apparatus according to one embodiment;

FIG. 30 is a schematic diagram of an identical left and right side view of a blade of a meat shredding apparatus according to one embodiment;

FIG. 31 is a schematic diagram of a top view of a blade of a meat shredding apparatus according to one embodiment;

FIG. 32 is a schematic diagram of a perspective view of a blade of a meat shredding apparatus according to one embodiment.

FIG. 33 is a schematic diagram of a perspective view cut through of a meat shredding apparatus according to one embodiment.

### DETAILED DESCRIPTION

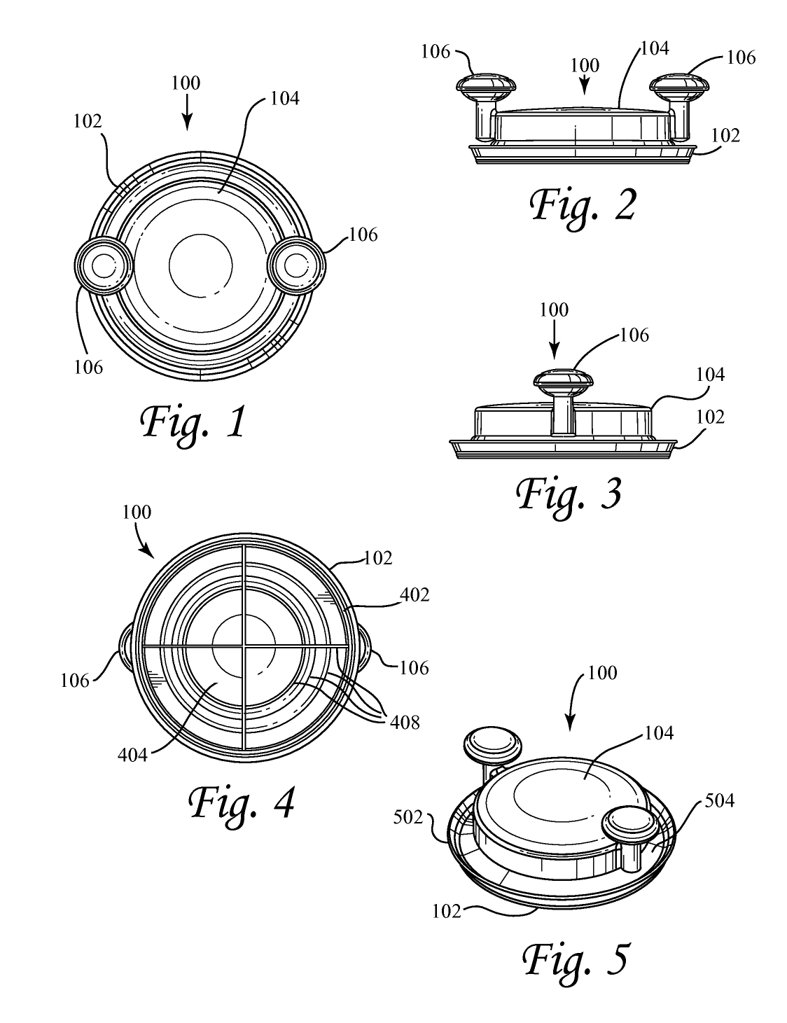

Referring now the drawings in greater detail, FIG. 1 shows the top view of a meat shredding apparatus 100 according to one embodiment. The apparatus according to this embodiment comprises a base portion 102, a lid portion 104, and two knobs 106. The apparatus 100 as depicted shows the lid portion 104 in place upon the base portion 102. The apparatus 100 may be operated by a user by rotating the lid portion 104 around the base portion 102. In embodiments, this may be done by hand using the knobs 106 to press down on the apparatus 100 and turn the lid portion 104 either, clockwise, counterclockwise, or back and forth in both clockwise and counterclockwise directions around the base portion 102. Other embodiments may have zero, one, or more than two knobs 106, or may have other means of allowing a user to rotate the lid portion 104 around the base portion, either by hand or using mechanical, electrical, or other means to turn the lid portion 104 or the base portion 102, or both.

The apparatus, according to various embodiments, may be comprised of any material that is sufficiently hard and durable, such as plastic, metal, ceramic, glass, hard rubber, carbon fiber composite materials, nylon or other natural or synthetic polymers, for example Acrylonitrile Butadiene Styrene (ABS), ABS glass filled nylon 6-6 (including ABS+20% glass filled nylon 6-6 as one example), carbon fiber reinforced polymers, or any combination of such materials, and may be washable either by hand or in a household or industrial dishwasher machine. In embodiments, the apparatus may also be comprised, in whole or in part, of nonstick material which prevents meat from sticking to it, or reduces the amount of meat that sticks to the apparatus.

FIG. 2 shows a front view of a meat shredding apparatus 100 according to one embodiment with a base portion 102, a lid portion 104, and two knobs 106. The front and rear views are identical according to one embodiment.

FIG. 3 shows a side view of a meat shredding apparatus 100 according to one embodiment, comprising a base portion 102, a lid portion, 104, and at least one knob 106. The left and right side views are identical according to one embodiment.

FIG. 4 shows a bottom view of a meat shredding apparatus 100 according to one embodiment. Depicted is the bottom of the base portion 102 according to one embodiment comprising a lower base plane 404, lower base ridges 408 which extend below the lower base plane 404 according to one embodiment, and a ring 402 which, according to one embodiment, is attached to and extends below the lower base plane 404. A ring 402, according to various embodiments, may be made of thermoplastic rubber (TPR), silicone, rubber, or other material or combination of materials that reduces or prevents the apparatus 100 from slipping when operated by a user, for example due to the material's stickiness or high coefficient of friction. In other embodiments, the entire lower base plane 404 or lower base ridges 408 of any size, shape, or configuration, could be made of or covered with TPR or other such a material as described for the ring 402.

FIG. 5 shows a perspective view of a meat shredding apparatus 100 according to one embodiment. In addition to the lid portion 104 and the base portion 102, a lip 502 extending from a base portion 102, and a ramp 504 are also depicted according to one embodiment. The lip 502 may be useful for both handling the apparatus 100 or the base portion 102, and may also be useful for catching and retaining any liquids released by meat that is shredded as a result of the operation of the apparatus 100. The lip 502, according to embodiments, may extend from the upper base plane 618, the lower base plane 404, or any other part of the base portion 102 according to various embodiments, and it may extend to any length and at any angle effective for catching liquids or manipulating the apparatus 100 according to various embodiments. As a particular example of acceptable dimensions for embodiments, the lip 502 may extend from 0.5 inches to 1.5 inches from the upper base plane at an angle of between 45 and 90 degrees. The ramp 504 may extend, for example, from the upper base plane 618 to the lower chamber housing 614 at any angle between 0 and 90 degrees.

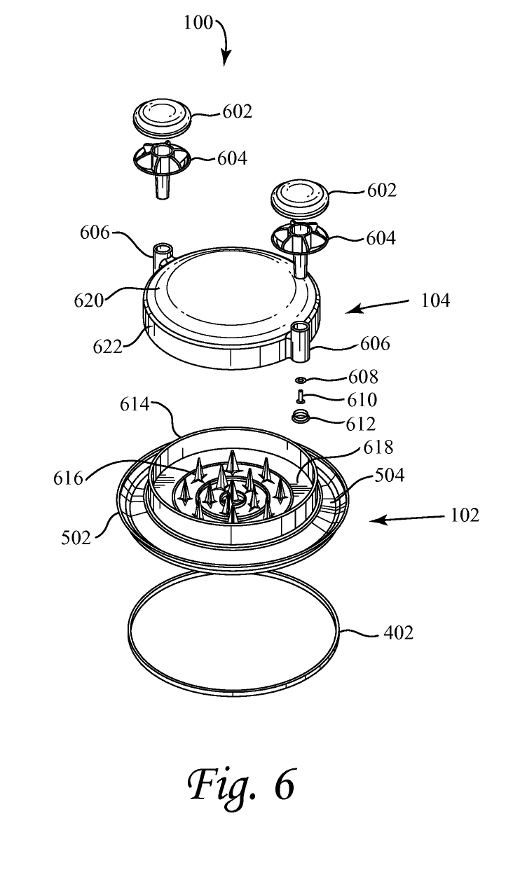

FIG. 6 shows an exploded view of a meat shredding apparatus 100 according to one embodiment. Knobs 102 are exploded into component knob tops 602 and topless knobs 604 according to one embodiment. The knobs 106 fit into the knob housings 606 which, according to one embodiment as depicted, are diametrically opposed on the lid portion 104 and extend tangentially from the lid portion 104. Other embodiments may have alternate placements for the knob housings 606, or if means other than knobs are used for rotating the lid portion 104 around the base portion 102, may have no knob housings at all. Also depicted according to one embodiment are a washer 608, a screw 610, and a knob housing cap 612 which secure the knob 106 within the knob housing 606 while allowing the knob 106 to rotate within the knob housing 606.

The lid portion 104 may fit over the base portion 102 creating a shredding chamber in the space between them according to embodiments. The lid portion 104, as depicted in the embodiment shown in FIG. 6, has an exterior lid top 620 and a shredding chamber wall 622.

The base portion 102, as depicted in the embodiment shown in FIG. 6, has a lower chamber housing 614 and an upper base plane 618. The upper base plane 618 may be either a substantially level plane, or may be concave or convex according to various embodiments. According to embodiments, the shredding chamber wall 622 fits around the lower chamber housing 614 to form a shredding chamber within the lid top 620, the upper base plane 618, and the lower chamber housing 614 and, to the extent it extends above the lower chamber housing 614, the shredding chamber wall 622. In other embodiments, the shredding chamber wall 622 may be placed within the lower chamber housing 614 so that the shredding chamber is formed within the shredding chamber wall 622, the upper base plane 618, and the lid top 620. In such embodiments, knob housings 606 may be attached to a lid top 620 rather than to a shredding chamber wall 622 to allow the shredding chamber wall 622 to fit within the lower chamber housing 614.

In embodiments, the lower chamber housing 614 and/or the shredding chamber wall 622 may have holes to allow any liquid released from cooked or uncooked meat during the operation of the apparatus 100 to drain out of the shredding chamber.

FIG. 6 also depicts basal blades 616 within the lower chamber housing 614 and on the upper base plane 618 of the base portion 102 according to one embodiment.

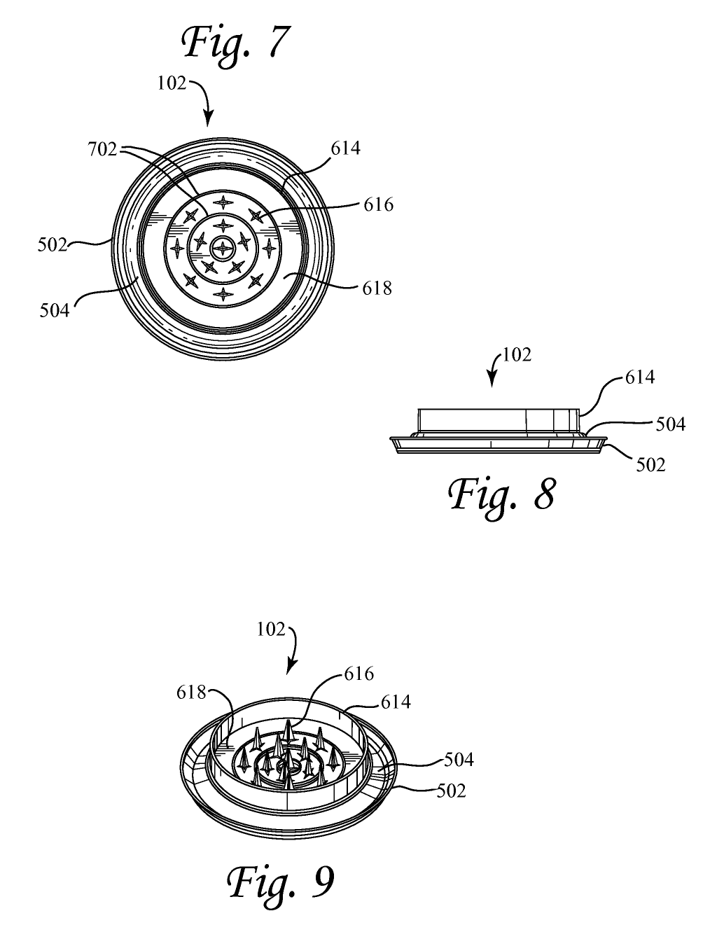

FIG. 7 shows a top view of a base portion 102 according to one embodiment. The base portion 102 may be of any shape or size sufficient to allow the shredding of cooked or uncooked meat according to various embodiments. The base portion 102 may be round in some embodiments, as it is in the embodiment depicted in FIG. 7, to match the shape of the lower chamber housing 614 and the shredding chamber wall 622. It may be of any size, according to various embodiments with exemplary sizes being 9.48 inches in diameter, 10.9 inches in diameter, and 11.01 inches in diameter. The ramp 504, according to the depicted embodiment, extends from the lip 502 and above the upper base plane 618 to the lower chamber housing 614.

Within the lower chamber housing 614, according to one embodiment as depicted in FIG. 7, are placed several raised basal ridges 702 along the upper base plane 618. These basal ridges 702 may reduce the surface area of the upper base plane 618 that contacts the meat to reduce the sticking of the meat to the apparatus during operation according to embodiments. The basal ridges 702 may also be positioned in rings between the basal blades 616 to aid in the shredding of the meat, according to embodiments.

The basal blades 616 may, according to embodiments, be a plurality of blades. Exemplary numbers of basal blades 616 are fourteen or twenty-one blades according to various embodiments.

The basal blades 616 may be sharp edged, pyramid-shaped blades of perpendicularly intersecting pairs of planar or tapered triangular blades wherein each pair of intersecting pairs of triangular blades shares an apex that serves as the point of the blade and has its base along the upper base plane 618, according to some embodiments and as depicted in FIG. 7.

The basal blades 616 may be evenly spaced according to embodiments, and may be arranged so that one blade is in the center of the lower chamber housing 614 and the remaining basal blades 616 may be arranged in concentric circles of rows of basal blades 616 around the blade in the center of the lower chamber housing 614. According to one embodiment, the basal blades 616 may be arranged in two rows around the blade in the center of the lower chamber housing 614 with the first row having five basal blades 616 and the second row having eight basal blades 616. Another embodiment may have three rows around the blade in the center of the lower chamber housing 614 with the first row having four basal blades 616, the second row having six basal blades 616, and the third row having ten basal blades 616. Other embodiments may have different arrangements for the basal blades 616 or may have different numbers of rows or numbers of basal blades 616 per row.

FIG. 8 shows a front view of the base portion 102 of a meat shredding apparatus 100 according to one embodiment. The front view is identical to views of the right, left, and rear according to the embodiment depicted. The front view of a base portion 102 depicts a lip 502, a ramp 504, and the lower chamber housing 614 according to one embodiment.

FIG. 9 shows a perspective view of a base portion 102 of a meat shredding apparatus 100 according to one embodiment. The perspective view of a base portion 102 of the embodiment as shown in FIG. 9 depicts a lip 502, a ramp 504, a lower chamber housing 614, an upper base plane 618, and basal blades 616.

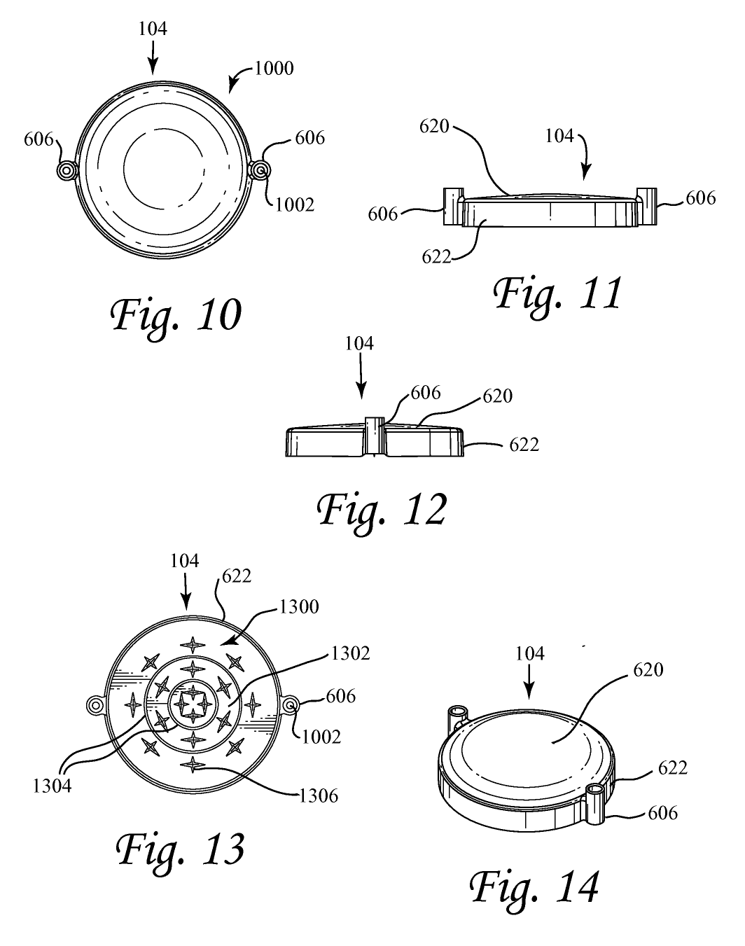

FIG. 10 shows a top view of a lid portion 104 of a meat shredding apparatus 100 according to one embodiment. This view depicts an exterior lid 1000 with two diametrically opposed knob housings 606 extending tangentially therefrom according to one embodiment. Also depicted are barrels 1002 within knob housings 606 within which may be placed a knob shaft 1602 of a knob 106 according to embodiments. A knob barrel 1002 may be of sufficient diameter to allow a knob shaft 1602 of a knob 106 to fit snugly within a barrel 1002 while allowing a knob shaft 1602 to rotate freely in response to any turning of a lid portion 104 of a meat shredding apparatus 100 around a lower chamber housing 614 of a base portion 102 according to embodiments. Other embodiments may have a solid knob 106 or knob top 602 attached to or integrated with a knob housing 606 so that neither a knob 106 nor a knob top 602 rotate. Still other embodiments may have a solid knob 106 attached to or integrated with a knob housing 606 while allowing a knob top 602 to rotate in response to hand turning by the user.

FIG. 11 shows a front view of a lid portion 104 of a meat shredding apparatus 100 according to one embodiment. According to the depicted embodiment, the front and rear views of the lid portion 104 are identical. FIG. 11 depicts a convex exterior lid top 620 according to one embodiment, but other embodiments may have flat or convex exterior lid tops 620. FIG. 11 also depicts a shredding chamber wall 622 of a lid portion 104 of a meat shredding apparatus, with two diametrically opposed knob housings 606 extending tangentially from a shredding chamber wall 622 according to one embodiment.

FIG. 12 depicts a side view of a lid portion 104 of a meat shredding apparatus 100 according to one embodiment. According to the depicted embodiment, the left and right side views are identical, but that is not necessarily so in other embodiments. FIG. 12 depicts a shredding chamber wall 622, an exterior lid top 620, and a knob housing 606.

FIG. 13 shows a bottom view of a lid portion 104 of a meat shredding apparatus according to one embodiment. Two diametrically opposed knob housings 606 with barrels 1002 for a knob shaft 1602 are attached tangentially to a round shredding chamber wall 622 which may fit over and rotate around a lower chamber housing 614 of a base portion 102 of a meat shredding apparatus 100 according to embodiments. A shredding chamber wall 622 of a lid portion 104 encloses an interior lid 1300. Within the interior lid 1300 is an interior lid plane 1302 which may be flat, concave, or convex according to various embodiments.

On the interior lid plane 1302 may be lid blades 1306 to aid in the shredding of meat, according to embodiments. The lid blades 1306 may, according to embodiments, be a plurality of blades. Exemplary numbers of lid blades 1306 are eighteen or twenty-eight blades according to various embodiments.

The lid blades 1306 may be sharp edged, pyramid-shaped blades of perpendicularly intersecting pairs of planar or tapered triangular blades wherein each pair of intersecting pairs of triangular blades shares an apex that serves as the point of the blade and has its base along the interior lid plane 1302, according to some embodiments and as depicted in FIG. 13.

The lid blades 1306 may be evenly spaced according to embodiments. The lid blades 1306 may be arranged so that any lid blades 1306 interlock with any basal blades 616 when a shredding chamber wall 622 of a lid portion 104 of a meat shredding apparatus 100 is placed around a lower chamber housing 614 of a base portion 102 of a meat shredding apparatus 100, and so that any lid blades 1306 and any basal blades 616 do not interfere with the rotation of a shredding chamber wall 622 around a lower chamber housing 614 by a user when the apparatus 100 is in operation. Interlocked basal blades 616 and lid blades 1306 may be placed for maximum shredding and/or most efficient shredding according to embodiments.

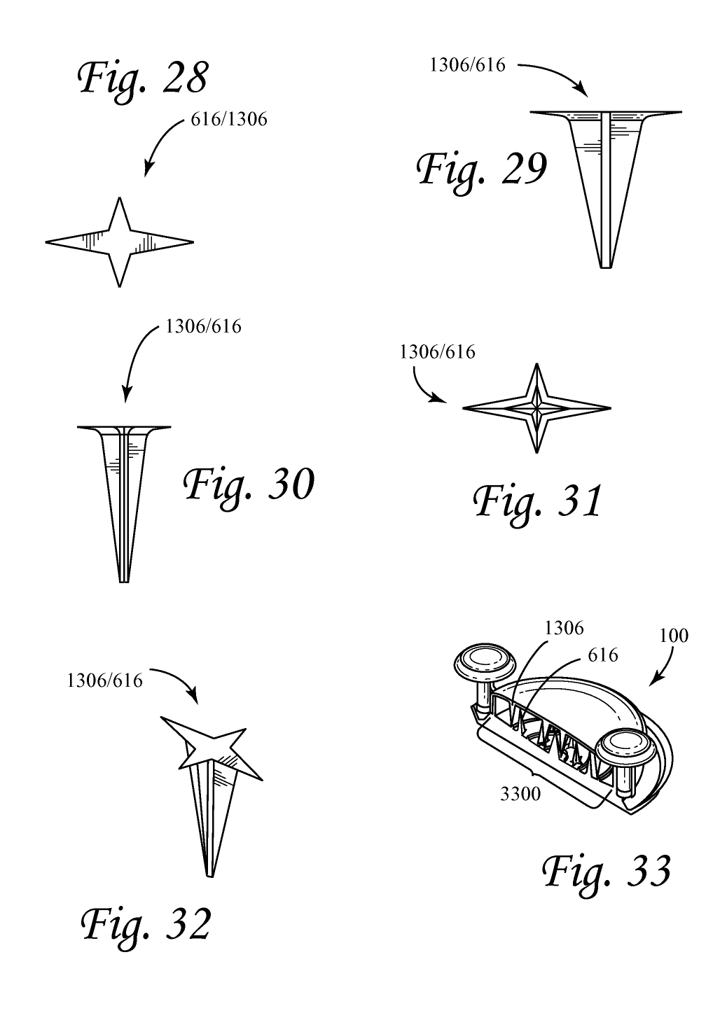

To understand the configuration of the basal blades 616 and lid blades 1306 according to one embodiment in more detail, FIG. 28 shows a top bottom view of the base of a blade for a meat shredding apparatus 100 according to one embodiment. The basal blade 616 or lid blade 1306 may be sharp edged (that is, sufficiently sharp to cut through either cooked or uncooked meat), pyramid-shaped blades of perpendicularly intersecting pairs of planar or tapered triangular blades wherein each pair of intersecting pairs of triangular blades shares an apex that serves as the point of the blade, as shown in the front view of a blade according to one embodiment as depicted in FIG. 29; the side view of a blade according to one embodiment as depicted in FIG. 30; the top view of a blade according to one embodiment as depicted in FIG. 29; and the perspective view of a blade according to one embodiment as depicted in FIG. 32. According to one embodiment as shown, the basal blades 616 and lid blades 1306 or of the same shape, but they may be different shapes according to different embodiments, and other embodiments may have blades of non-uniform shape. Blades of other shapes, or blades that intersect at angles other than right angles and are not perpendicular (or substantially perpendicular) may be used in other embodiments. Blades of a single plane (rather than intersecting planes) may also be used in some embodiments.

To understand the alignment of the basal blades 616 and the lid blades 1306 when the lid portion 104 is placed upon the base portion 102 to form a shredding chamber 3300, FIG. 33 shows a cut-away view of a meat shredding apparatus 100 according to one embodiment. As shown in the depicted embodiment, the basal blades 616 and lid blades 1306 align in rows of varying distance from the center of the shredding chamber 3300 so that each row on the base portion 102 and the lid portion 104 will maintain a different orbit around the center of the shredding chamber or otherwise not interfere with one another when the lid portion 104 is rotated around the base portion 102 (or vice versa) when the apparatus is in operation.

The basal blades 616 and lid blades 1306 may be made of the same material or may be made of varying material according to embodiments. Different embodiments may have varying degrees of sharpness, but the apex of the blades should be sufficiently sharp to penetrate cooked meat or uncooked meat (but not necessarily both) and proceed through it when the lid portion 104 and the base portion 102 are pressed together. The edges of the blade may also have varying degrees of sharpness but should be able to cut through cooked meat or uncooked meat (but not necessarily both) when the lid portion 104 is rotated around the base portion 102 (or vice versa) when the apparatus is in operation.

The blades may be comprised of any material that is sufficiently hard to withstand impact with and cutting through meat. Some exemplary materials are plastic, metal including stainless steel, ceramic, glass, hard rubber, carbon fiber composite materials, carbon fiber reinforced polymers, nylon or other natural or synthetic polymers, for example Acrylonitrile Butadiene Styrene (ABS), ABS glass filled nylon 6-6 (including ABS+20% glass filled nylon 6-6 as one example), which may be strong, rigid, resistant to oils, abrasion resistant, easily machined, and easily bonded.

The apex of the basal blades 616 may be of sufficient height above the upper base plane 618 to reach across, or nearly across, the shredding chamber to reach (or nearly reach) the interior lid plane 1302 when a lid portion 104 is in place upon a base portion 102 for operation of the device according to some embodiments. Likewise, the apex of the lid blades 1306 may be of sufficient height above the interior lid plane 1302 to reach across (or nearly across) the shredding chamber to reach (or nearly reach) the upper base plane 618 when the lid portion 104 is in place upon the base portion 102 for operation of the device according to some embodiments.

According to embodiments, the lid blades 1306 may be arranged so that no blade is in the center of the interior lid 1300 and the lid blades 1306 are arranged in concentric circles of rows of lid blades 1306 around center of the interior lid 1300.

According to one embodiment, the lid blades 1306 may be arranged in three rows around the center of the interior lid 1300 with the first row having four lid blades 1306, the second row having six lid blades 1306, and the third row having eight lid blades 1306.

Another embodiment may have four rows of lid blades 1306 around the center of the interior lid 1300 with the first row having four lid blades 1306, the second row having six lid blades 1306, the third row having eight lid blades 1306, and the fourth row having ten lid blades 1306. Other embodiments may have different arrangements for the lid blades 1306 or may have different numbers of rows or numbers of lid blades 1306 per row.

Raised lid ridges 1304 may also be located on the interior lid plane 1302. These lid ridges 1304 may reduce the surface area of the interior lid plane 1302 that contacts the meat to reduce the sticking of the meat to the apparatus during operation according to embodiments. The lid ridges 1304 may also be positioned in rings between the lid blades 1306 to aid in the shredding of the meat, according to embodiments.

FIG. 14 shows a perspective view of a lid portion 104 of a meat shredding apparatus 100 according to one embodiment. Depicted, according to one embodiment, are a lid top 620, a shredding chamber wall 622, and two diametrically opposed knob housings 606 attached tangentially to the shredding chamber wall and extending out therefrom.

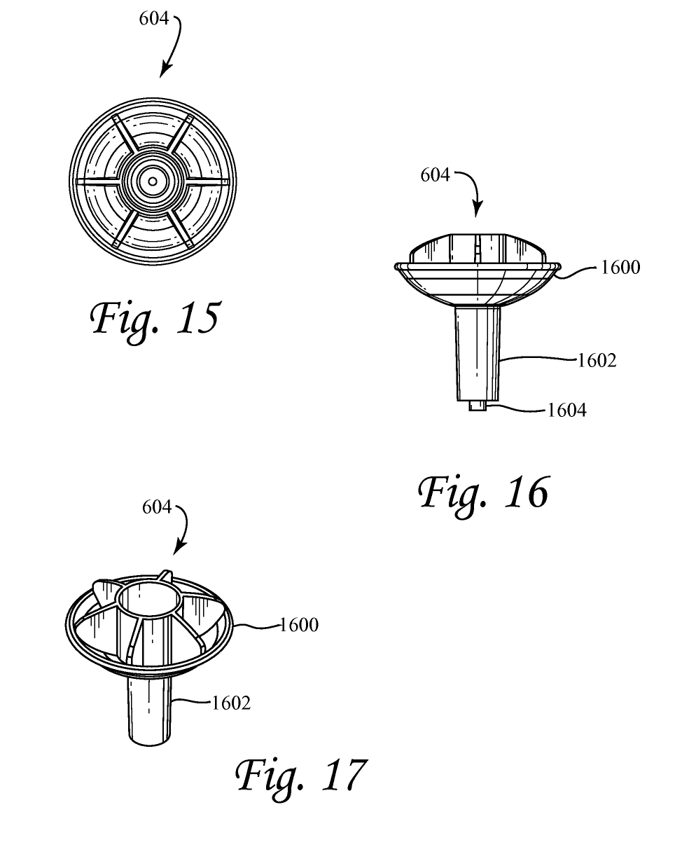

FIG. 15 depicts a top view of a topless knob 604 according to one embodiment.

FIG. 16 depicts a front view of a topless knob 604 according to one embodiment. The topless knob as depicted in the embodiment shown in FIG. 16 may have a knob shaft 1602 that may be rounded to facilitate rotation within a barrel 1002 of a knob housing 606 according to one embodiment. The knob shaft 1602, for example, may be cylindrical or may be tapered so as to resemble a cone with or without a point in embodiments.

Extending from the top of the knob shaft may be a knob flange 1600 according to embodiments and as depicted in FIG. 16. The knob flange may be topless as depicted in FIG. 16 and capable of connecting with a knob top 602 according to some embodiments, or it may have a top according to some embodiments. A knob 106 with a top (or a topless knob 604 with a knob top 602 in place) may be of a size and shape to comfortably fit in the palm of a user, and allow the user to grasp the knob top 602 and knob flange 1600 when operating the device. In particular, for example, the knob flange 1600 and any necessary knob top 602 may be round or oval according to some embodiments. The knob shaft may be hollow and of a diameter sufficient to receive the screw 610. The knob shaft may also be threaded to match the threading of the screw 610. The screw 610 may be unthreaded. The knob 106 may be able to rotate around the screw 610 when the screw 610 is in place within the knob shaft 1602.

At the bottom of the knob shaft 1602 is a knob tooth 1604 according to one embodiment. The knob tooth 1602 may serve as an entranceway for the screw 610 to the threaded or unthreaded hollow of the knob shaft 1602.

FIG. 17 shows a perspective view of a topless knob 604 of a meat shredding apparatus according to one embodiment. Depicted in FIG. 17 are a knob flange 1600 and a knob shaft 1602.

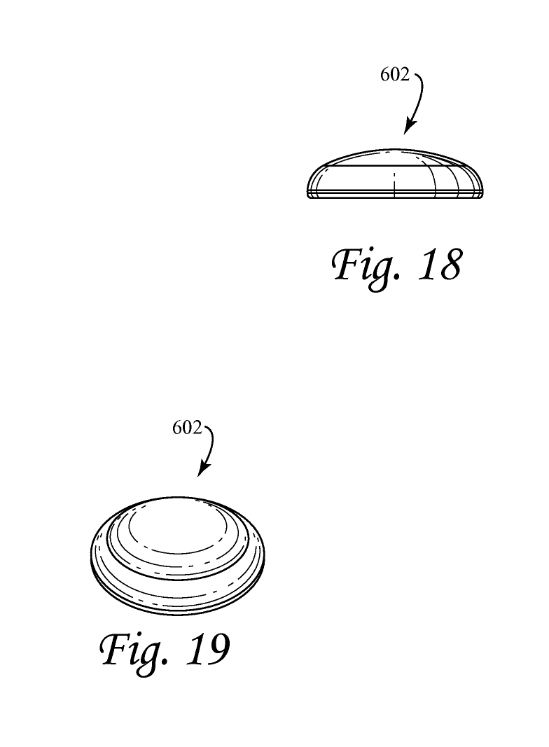

FIG. 18 shows a front view of a knob top 602 for a knob 106 of a meat shredding apparatus according to one embodiment. According to the depicted embodiment, the front view, rear view, and all side views of the knob top 602 are identical. In other embodiments, the knob top may be oval or any other shape that fits into the hand of the user, or any shape that allows for operation of the device and the rotation of the shredding chamber wall 622 around or within the lower chamber housing 614. The knob top 602 may be rounded for the comfort of the user in embodiments. The knob top may fit onto or into the top of the topless knob 604.

FIG. 19 shows a perspective view of a knob top 602 according to one embodiment.

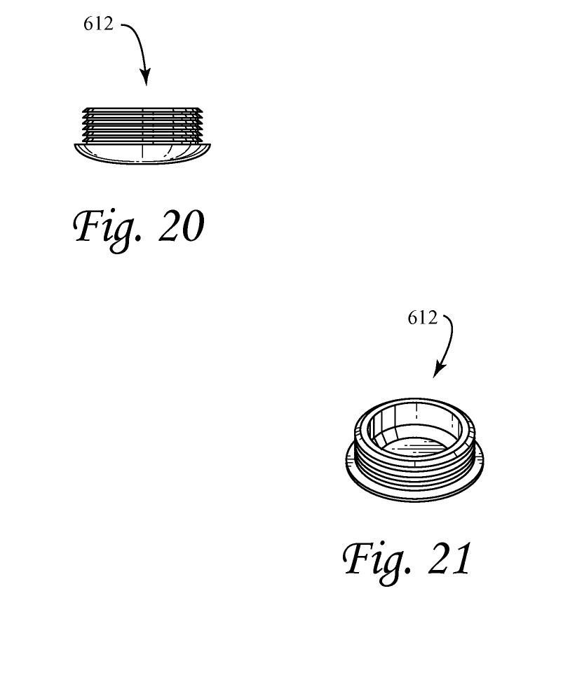

FIG. 20 shows a front view of a knob housing cap 612 according to one embodiment. In the embodiment depicted, the front, rear, and side views are identical because the knob housing cap 612 is round. In other embodiments, however, the knob housing cap may be of any shape that fits into the knob housing 606. The knob housing cap may, according to various embodiments, be decorative or it may function to secure the screw 610 and/or the washer 608 within the hollow of the knob shaft 1602 and the knob housing barrel 1002. The knob housing cap 612 may be threaded for crewing into the knob housing 606 (which may also be threaded) or it may be secured by other means such as a snapping mechanism or glue.

FIG. 21 shows a perspective view of a knob housing cap 612 according to one embodiment.

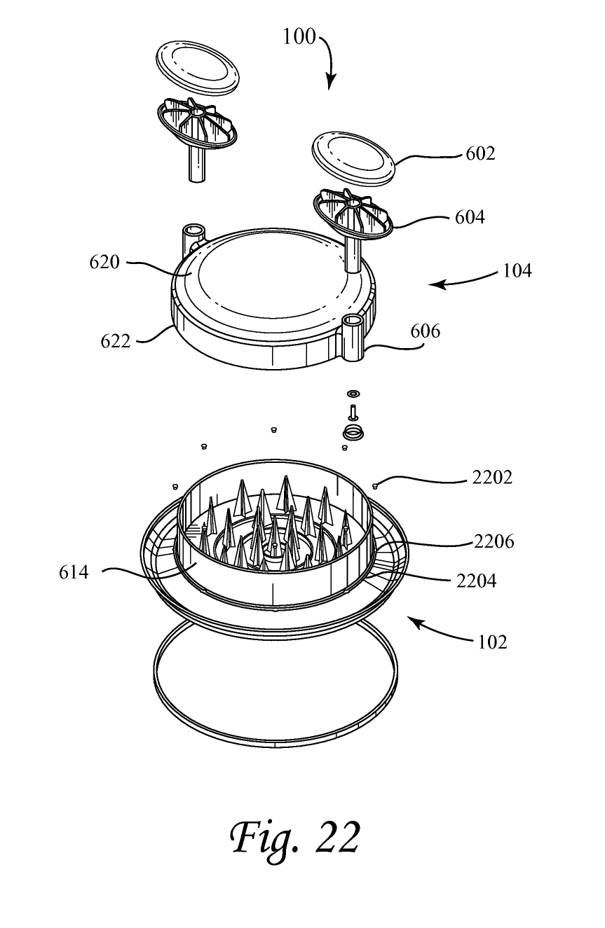

FIG. 22 shows an exploded view of a meat shredding apparatus 100 according to one embodiment. The embodiment depicted in FIG. 22 has alternative oval shaped topless knobs 604 and complementary oval shaped knob tops 602. The embodiment depicted in FIG. 22 also has a snap runner 2204 along the base of a lower chamber housing 614 with snap holes 2206 in which snaps 2202 may be secured. Snaps 2202 may be placed at intervals along a snap runner 2204 according to embodiments. Snaps may rise above the surface of a snap runner 2204 and serve to reduce the contact between a base portion 102 of an apparatus 100 and a shredding chamber wall 622 when an apparatus is in operation and a shredding chamber wall 622 is rotated around (or within) a lower chamber housing 614. This may serve to reduce friction between a base portion 102 of an apparatus 100 and a shredding chamber wall 622 when an apparatus is in operation and make an apparatus 100 easier to use.

In embodiments, a snap runner 2204 and snaps 2202 may be placed within a lower chamber housing 614 and a shredding chamber wall 622 may rotate within a lower chamber housing 614. In such embodiments, knob housings 606 may be attached to a lid top 620 rather than to a shredding chamber wall 622 to allow the shredding chamber wall 622 to fit within the lower chamber housing 614.

In alternative embodiments snaps may be placed on the lid portion.

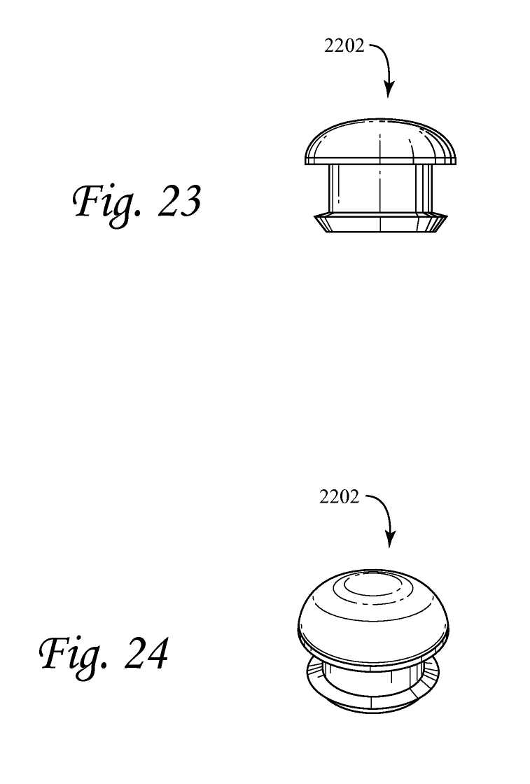

FIG. 23 shows a front view of a snap 2202 according to one embodiment. The front view of the snap depicted is identical to the rear and side views, but in other embodiments the snap 2202 need not be circular.

FIG. 24 shows a perspective view of a snap 2202 according to one embodiment. Snaps 2202 may be comprised of the same material as snap runner 2204 or base portion 102, or may be composed of a different material, such as any material that has a lower coefficient of friction and makes the lid portion 104 and base portion 102 easier to rotate around each other.

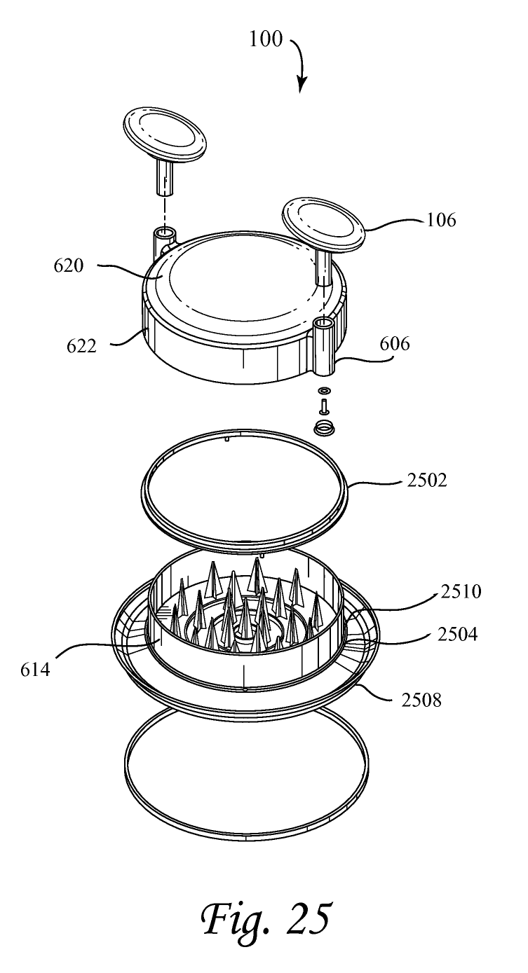

FIG. 25 shows an exploded view of a meat shredding apparatus 100 according to one embodiment. The embodiment depicted in FIG. 25 has alternative oval shaped knobs 106. The embodiment depicted in FIG. 25 also has a slider runner 2504 at the base of the exterior of a lower chamber housing 614 with slider teeth holes 2510 which may receive and secure slider teeth 2600 on a slider 2502. A slider 2502, secured to a base portion 2508 of a meat shredding apparatus 100 with slider teeth 2600 placed in slider teeth holes 2510, may serve to reduce the friction between a base portion 2508 of an apparatus 100 and a shredding chamber wall 622 when the apparatus is in operation and make the apparatus 100 easier to use. A shredding chamber wall 622 may fit onto a slider 2502 and rotate thereon around a lower chamber housing 614. A slider 2502 may also be placed within a lower chamber housing 614 and facilitate rotation of a shredding chamber wall 622 within a lower chamber housing 614. In such embodiments, knob housings 606 may be attached to a lid top 620 rather than to a shredding chamber wall 622 to allow the shredding chamber wall 622 to fit within the lower chamber housing 614.

In alternative embodiments the slider may be placed on the lid portion.

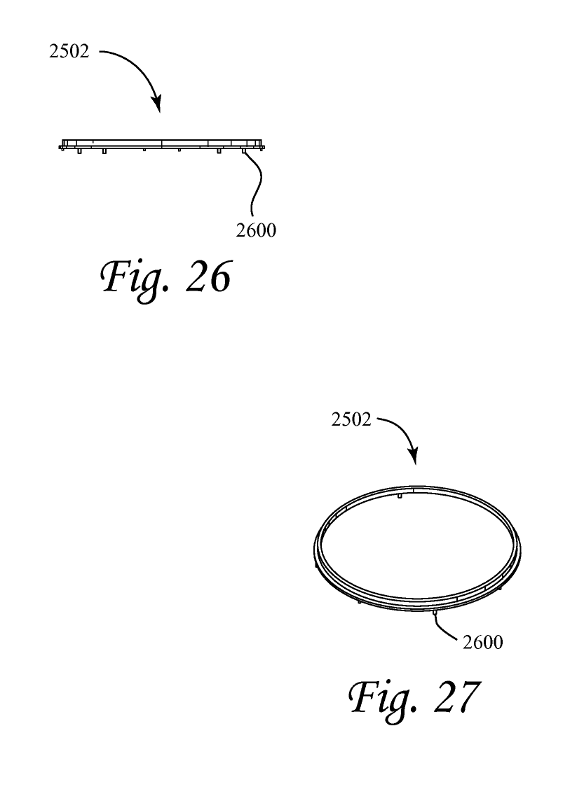

FIG. 26 shows a front view of a slider 2502 with slider teeth 2600 according to one embodiment. According to the depicted embodiment, the slider is circular and the slider teeth 2600 are placed at regular intervals such that the front, rear, and side views of the slider 2502 are identical. In other embodiments this may not be so.

FIG. 27 shows a perspective view of a slider 2502 with slider teeth 2600 according to one embodiment. A Slider 2502 may be comprised of the same material as slide runner 2504 or base portion 102, or may be composed of a different material, such as any material that has a lower coefficient of friction and makes the lid portion 104 and base portion 102 easier to rotate around each other.

According to one embodiment, a meat shredding apparatus may be operated by a user according to the following method: A base portion 102 of an apparatus 100 may be placed on any surface such as a counter or tabletop with a lower base plane 404 down so that the lower base plane 404 or any lower base ridges 408 and/or rings 402 are in contact with a surface.

Cooked or uncooked meat, including without limitation any meat consumed by humans or animals (specifically including without limitation chicken, beef, fish, and pork) may be placed on any basal blades 616 within the lower chamber housing 614.

A lid portion 104 may be placed by a user on top of any cooked or uncooked meat placed, for example, on the apex of the basal blades 616 and within the lower chamber housing, and a user may place the lid portion 104 on top of the meat so that the apex of the lid blades 1306 is on top of the meat. The user may manually press a lid portion 104 down by placing the user's hands on one or more knobs 106 or a lid top 620 or any portion of the lid 104 so that a shredding chamber wall 622 is around a lower chamber housing 614 and a shredding chamber wall 622, 2222, 2522 is close to or in contact with a ramp 504 or any part of a base portion 102, or snaps 2202, or a slider 2502. In alternative embodiments, the base portion 102 may be pressed up into the lid portion 104. In alternative embodiments the shredding chamber wall 622 may be placed within the lower chamber housing 614. In such embodiments, knob housings 606 may be attached to a lid top 620 rather than to a shredding chamber wall 622 to allow the shredding chamber wall 622 to fit within the lower chamber housing 614.

When a base portion 102 and lid portion 104 are pressed together with the meat in place, a shredding chamber is created which contains the meat within. The lid blades 1306 and the basal blades 616 may cut into the meat beginning at a pointed apex of the blades. The basal blades 616 and the lid blades may interlock within a shredding chamber as they cut into the meat.

When the lid portion 104 is placed on the base portion 102 and the shredding chamber is created, the user may press down on a lid portion 104 and rotate a lid portion 104 around a lower chamber housing 614 of a base portion 102, thus moving the blades in the shredding chamber through the meat and shredding the meat. The user may rotate clockwise, counterclockwise, or in any combination of directions back and forth around a lower chamber housing 614. The user may turn a lid portion 104 using any part of the lid portion 104 including any knobs 106.

In embodiments, any knob shafts 1602 may rotate within a barrel 1002 of a knob housing, and may also rotate around a screw 610 within a knob shaft 1602.

The user may remove a lid portion 104 from the base portion 102, and then remove the shredded meat from within a lower chamber housing 614 and/or the interior lid 1300.

Any liquid released from the meat may be collected within a lower chamber housing 614 or may run from the lower chamber housing 614 along a ramp 504 and be collected between a ramp 504 and a lip 502. Such liquid can be poured from a lip 502 to any place the user chooses. A lip 502 may be equipped with a spout to aid in the pouring of such liquid.

In embodiments, the shredded pieces of the meat may be of similar diameter.

The claims as originally presented, and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. Apparatus comprising:
a base portion comprising a lower chamber housing;
wherein plural blades are located on the base portion within the lower chamber housing; and
a lid portion comprising a shredding chamber wall that encloses an interior lid;
wherein the interior lid comprises plural blades;
and wherein the shredding chamber wall fits together with the lower chamber housing when the lid portion and the base portion are placed together to form a shredding chamber; and
wherein the lid portion and the lower chamber housing may be rotated around each other when the shredding chamber is formed to shred any meat located within the shredding chamber.

2. The apparatus according to claim 1 wherein the plural blades of the interior lid interlock with the plural blades of the base portion.

3. The apparatus according to claim 1 wherein the apparatus is comprised of ABS glass filled nylon 6-6.

4. The apparatus according to claim 1 wherein the apparatus is comprised of metal.

5. The apparatus according to claim 1 wherein the base portion comprises a lower base plane which further comprises a ring made of thermoplastic rubber.

6. The apparatus according to claim 1 wherein the blades are sharp edged, pyramid-shaped blades of perpendicularly intersecting pairs of tapered triangular blades.

7. The apparatus according to claim 6 wherein the intersecting pairs of triangular blades shares and apex and has its base along a lower base plane.

8. The apparatus according to claim 1 wherein the blades on the interior lid and the blades on the base portion are arranged so that they do not interfere with the rotation of the lid portion around the lower chamber housing.

9. The apparatus according to claim 1 wherein the base portion comprises a lip.

10. The apparatus according to claim 9 wherein the base portion further comprises a ramp between the lip and the lower chamber housing.

11. The apparatus according to claim 1 wherein the lid portion comprises two knob housings with hollow barrels extending from the shredding chamber wall, and further comprises two knobs with knob shafts that fit within and rotate freely within the barrels of the knob housings.

12. The apparatus according to claim 11 wherein the knob housings are diametrically opposed on the lid portion.

13. The apparatus according to claim 11 wherein the knobs comprise rounded tops.

14. The apparatus according to claim 11 wherein the knobs comprise oval tops.

15. The apparatus according to claim 1 wherein the base portion comprises a snap runner with snaps.

16. The apparatus according to claim 1 wherein the base portion comprises a slider.

17. A method wherein
meat is placed is placed on blades on a base portion of a shredding apparatus;
a lid portion of a shredding apparatus with blades is placed on top of the meat; and
the lid portion and base portion are pressed together to form a shredding chamber wherein the blades penetrate the meat; and
wherein the lid portion is rotated around the base portion to move the blades through the meat.

18. The method according to claim 17 wherein the meat is cooked.

19. The method according to claim 17 wherein the lid portion is rotated around the base portion using knobs.

20. The method according to claim 19 wherein the knobs have rounded tops.
